(19) United States
(12) Patent Application Publication
(10) Pub. No.: US 2017/0341146 A1
(43) Pub. Date: Nov. 30, 2017

(54) POWDER HANDLING SYSTEM FOR USE IN POWDER BED FUSION ADDITIVE MANUFACTURING

(71) Applicant: EDISON WELDING INSTITUTE, INC., Columbus, OH (US)

(72) Inventors: Mahdi JAMSHIDINIA, Columbus, OH (US); Paul C. BOULWARE, Columbus, OH (US); Lance CRONLEY, Mt. Victory, OH (US); Jacob MARCHAL, Rapid City, SD (US); Heimdall MENDOZA, Columbus, OH (US)

(21) Appl. No.: 15/603,888

(22) Filed: May 24, 2017

Related U.S. Application Data
(60) Provisional application No. 62/340,650, filed on May 24, 2016.

(51) Int. Cl. B22F 3/105; B33Y 30/00; B33Y 70/00; B22F 3/00

(52) U.S. Cl. CPC B22F 3/1055; B22F 3/004; B33Y 30/00; B33Y 70/00; B22F 2003/1057

(57) ABSTRACT

A powder handling system that includes a first powder deposition device for depositing a primary powder on a surface at a predetermined speed; and a second powder deposition device for depositing a secondary powder onto the primary powder in at least two directions relative to the surface, wherein the second powder deposition device includes a reservoir for containing the secondary powder; and a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, or a combination thereof.

### CROSS-REFERENCE TO RELATED APPLICATIONS

This patent application claims the benefit of U.S. Provisional Patent Application Ser. No. 62/340,650 filed on May 24, 2016 and entitled “Powder Handling System for Use in Powder Bed Fusion Additive Manufacturing”, the disclosure of which is hereby incorporated by reference herein in its entirety and made part of the present U.S. utility patent application for all purposes.

### STATEMENT REGARDING FEDERALLY FUNDED RESEARCH

This invention was made with Government support under prime contract number 70NANB13H192 awarded by the Department of Commerce (DoC). The Government has certain rights in the invention.”

### BACKGROUND OF THE INVENTION

The described invention relates in general to additive manufacturing systems, devices, and processes, and more specifically to a powder handling system for powder bed fusion additive manufacturing used for fabricating multi-material metallic components.

In general, the powder bed fusion (PBF) process utilizes either a laser or an electron beam to melt and fuse material powder for creating a part or component. PBF processes typically involve the spreading of the material powder over previously deposited layers of material. There are different mechanisms for accomplishing this including, for example, the use of a roller or a blade. A hopper or a reservoir positioned below or next to the powder bed is used to provide fresh material powder. Electron beam powder bed fusion (EB-PBF), also known as electron beam melting (EBM), requires a vacuum, but can be used with metals and alloys in the creation of functional parts. Laser powder bed fusion (L-PBF), also known as selective laser melting (SLM), or direct metal laser melting (DMLM), is equivalent to selective laser sintering (SLS), but involves the use of metals rather than plastics. Also, in L-PBF, the material fully melts, whereas in SLS, the material partially sinters. Selective heat sintering (SHS) differs from other processes by using a heated thermal print head for fusing material powder. As before, layers are added with a roller in between fusion of layers and a platform lowers the part accordingly.

L-PBF is an additive manufacturing (AM) process in which a three-dimensional component or part is built using a layer-by-layer approach. L-PBF typically involves the following general steps: (i) a layer of powdered material (e.g., metal), typically about 0.04 mm thick, for example, is spread over a build platform or plate; (ii) a laser fuses the first layer or first cross-section of the part; (iii) a new layer of powder is spread across the previous layer using a roller or similar device; (iv) further layers or cross sections are fused and added; and (v) the process is repeated until the entire part is created. Loose, unfused powdered material remains in position, but is removed during post processing.

Additive manufacturing systems that are currently in use are limited to the application of a single powdered material at any given time. For the initial application, the powdered material, which is stored in a dispenser is slightly raised. The powder is then spread over a build plate using a powder spreading device (e.g., recoater arm). Even though this method is an appropriate and acceptable technique for spreading powder particles, it is not appropriate for the fabrication of multi-material components. Using current commercially available PBF systems, the chemical composition of a component could be gradually changed along the buildup direction (Z direction). Two powders may be stored in the dispenser, in a manner that permits the chemical composition of the mixture to gradually change along the depth of the mixture. Using such a mixture, a multi-material component could be produced that includes a gradual change in chemical composition along its height. However, a limitation of this method would be that the chemical composition could only be changed along the buildup direction, making it not possible to create a single spot or location within the component that has a different chemistry surrounded by the baseline matrix. Another disadvantage of this method would be that the resultant mixing of two different powders over the entire build platform and collection area that would create a mixture that would be difficult to separate, if desired. The ability to reuse powder significantly drives down the cost of using powder bed fusion AM techniques and the savings associated with reductions in material waste is one of the major advantages of AM processes. Thus, there is an ongoing need for a workable, cost-effective system for using PBF systems to create complex multi-material metallic components.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first powder handling system for use in powder bed fusion additive manufacturing is provided. This powder handling system includes a first powder deposition device for depositing a primary powder on a surface at a predetermined speed; and a second powder deposition device for depositing a secondary powder onto the primary powder in at least two directions relative to the surface, wherein the second powder deposition device includes a reservoir for containing the secondary powder; and a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, or a combination thereof.

In another aspect of this invention, a second powder handling system for use in powder bed fusion additive manufacturing is provided. This powder handling system includes a first powder deposition device for depositing a primary powder on a surface at a predetermined speed, wherein the wherein the first powder deposition device further includes a recoater arm; and a second powder deposition device for depositing a secondary powder onto the primary powder in at least two directions relative to the surface, wherein the at least two directions include movement along the X-axis of the surface and movement along the Y-axis of the surface, and wherein the second powder deposition device includes a reservoir for containing the secondary powder; and a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, or a combination thereof.

In yet another aspect of this invention, a third powder handling system for use in powder bed fusion additive manufacturing is provided. This powder handling system includes a first powder deposition device for depositing a primary powder on a surface at a predetermined speed, wherein the wherein the first powder deposition device further includes a recoater arm; and a second powder deposition device for depositing a secondary powder onto the primary powder in at least two directions relative to the surface, wherein the at least two directions include movement along the X-axis of the surface and movement along the Y-axis of the surface, and wherein the second powder deposition device includes a reservoir for containing the secondary powder; and a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, adjusting the speed of the first powder deposition device, or a combination thereof.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a perspective view of an assembled powder handling system in accordance with an exemplary embodiment of the present invention;

FIG. 2 is an exploded view of the powder handling system of FIG. 1 showing the placement and attachment of the recoater arm, vertical adjustment unit, powder hopper, rotating shaft, stepping motor, and powder delivery funnel;

FIG. 3 is a photograph of a powder handling system in accordance with an exemplary embodiment of the present invention, wherein the system is used for the deposition of a secondary powder in an L-PBF process;

FIG. 4 includes multiple photographic images depicting the six levels of contamination deposition for tungsten;

FIG. 5 includes multiple photographic images depicting the six levels of contamination deposition for AlSi10Mg;

FIG. 6 provides a three-dimensional reconstruction of the specimen contaminated with tungsten powder particles, wherein the black arrow shows the powder recoating; and

FIG. 7 includes multiple photographic images depicting horizontal cross-sectional views of the specimen contaminated with the tungsten powder showing the six contamination levels along the buildup direction (shown by the white arrow).

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

This invention is useful in various industries including the aerospace, oil and gas, and automotive industries with regard to the fabrication of multi-material components using L-PBF processes. These performance-driven industries are largely focused on the use of powder bed fusion processes for creating components that have a uniform chemistry based on what is achievable with current commercially available technology. The present invention provides the ability to alter chemistry locally within a layer (as opposed to globally within a layer) in a more cost effective manner than previously possible. As a result of such chemical alteration, the properties of a produced component are tunable, leading to further gains in performance. Applications of this invention include, for example, the identification of different materials for hard facing gears; the tailoring of stiffness, strength and toughness in aerospace, medical and automotive components; optimizing heat transfer in tooling or heat exchangers; and locally adding corrosion resistant material for internal channels. The powder handling system of the present invention permits the fabrication of multi-material components with high precision and resolution. With the application of this system, L-PBF processes may be used to change chemical composition along two or more axes (degrees of freedom). As described below, hardware and software settings may be adjusted to achieve multiple rates of powder feed.

As previously indicated, the present invention relates to additive manufacturing systems, devices, and processes, and more specifically to a powder handling system for powder bed fusion additive manufacturing used for fabricating multi-material metallic components. Exemplary embodiments of this powder handling system enable the fabrication of components that include multiple materials through the use of additive manufacturing techniques. At least two different powders are used for the fabrication of a component: (i) a primary powder is spread over a build plate using a moving arm; and (ii) a secondary power is carried in a hopper, while a rotating shaft delivers the secondary powder onto the primary powder. Powder deposition rate is controlled through adjusting rotating speed, rotating angle, number of rotations of the shaft, adjusting notch geometry of the shaft, and optionally, adjusting the speed of the recoater arm. The deposition setup in prior art systems typically includes two degrees of freedom while spreading powder on a powder bed. The powder handing system of this invention effectively addresses that limitation and the disadvantages discussed above. Because a mechanism other than the recoater arm is used for the delivery of a secondary powder, any undesired mixing between primary and secondary powders is eliminated. Also, a change in chemical composition will not be limited to only the buildup direction (Z plane), rather the chemical composition can be precisely changed on the XY plane, which is very important with regard to industrial applications.

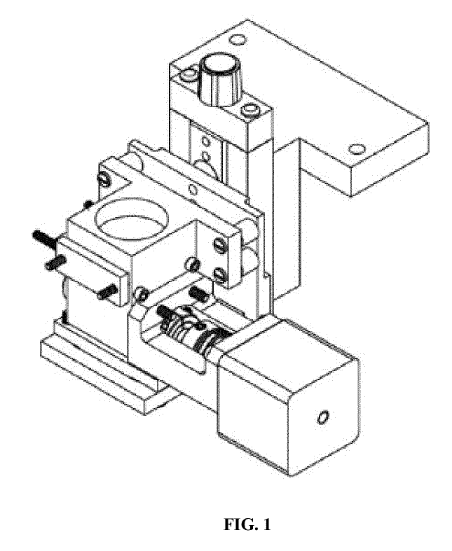

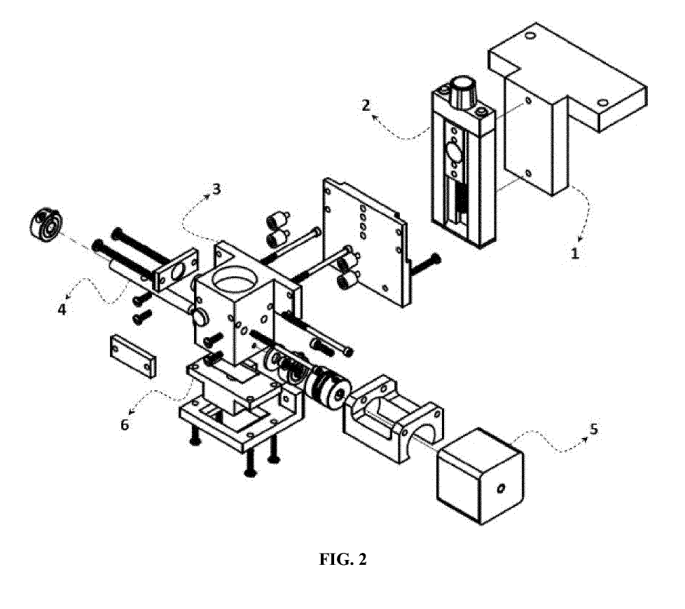

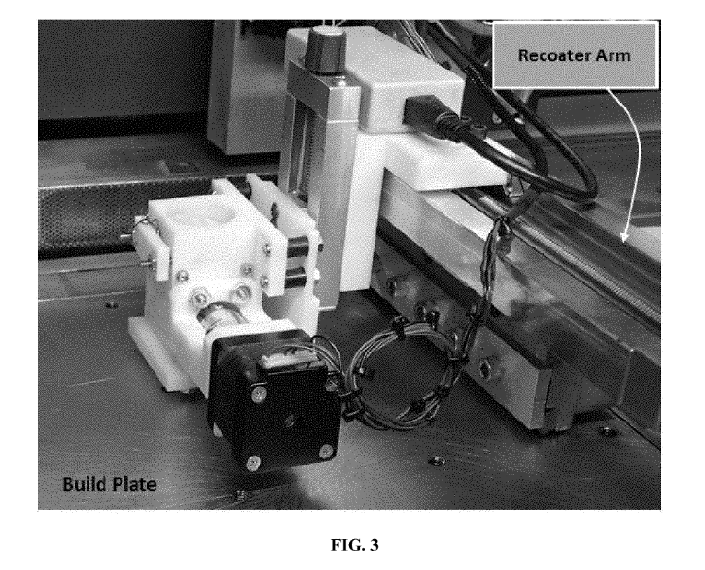

FIG. 1 provides a perspective view of a fully-assembled powder handling system in accordance with an exemplary embodiment of the present invention and FIG. 2 provides an exploded view of the same system. In this embodiment, the powder handling system is bolted to a metal sheet (1) to be attached to the powder spreading mechanism (e.g. recoater arm). To achieve a desired powder chemistry distribution, the distance between the powder handling system and powder top surface should be properly adjusted. This may be accomplished using an adjustment unit (2) that moves the powder handling system along the buildup direction (e.g., up and down). A funnel-shaped hopper (3) that stores a secondary powder is attached on the top of the powder handling system. A cylindrical shaft (4) is embedded inside the powder handling system, with the ability to rotate along its axis. The shaft meets the bottom exit point of the hopper (3) and acts as a barrier against powder leakage from the hopper. The rotation motion of the shaft is provided using a stepping motor (5). In this embodiment, there is a very small gap between the shaft and its housing and the powder could leak from the hopper only if the shaft starts to rotate. The powder will fall into the powder delivery funnel (6). The specific design of the delivery funnel could generate a powder distribution profile, as desired. FIG. 3 shows the powder handling system assembled on the recoater arm. The metallic substrate under the entire setup is labeled as the representative of a build plate.

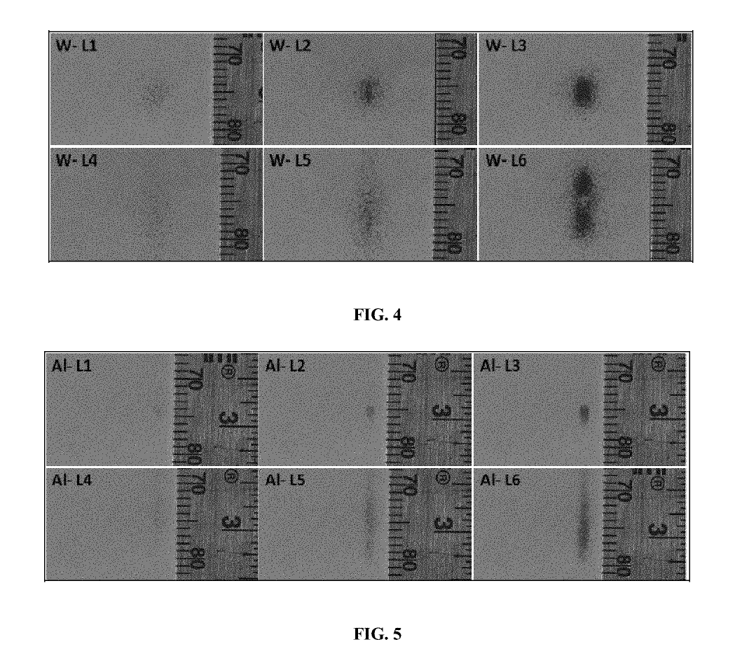

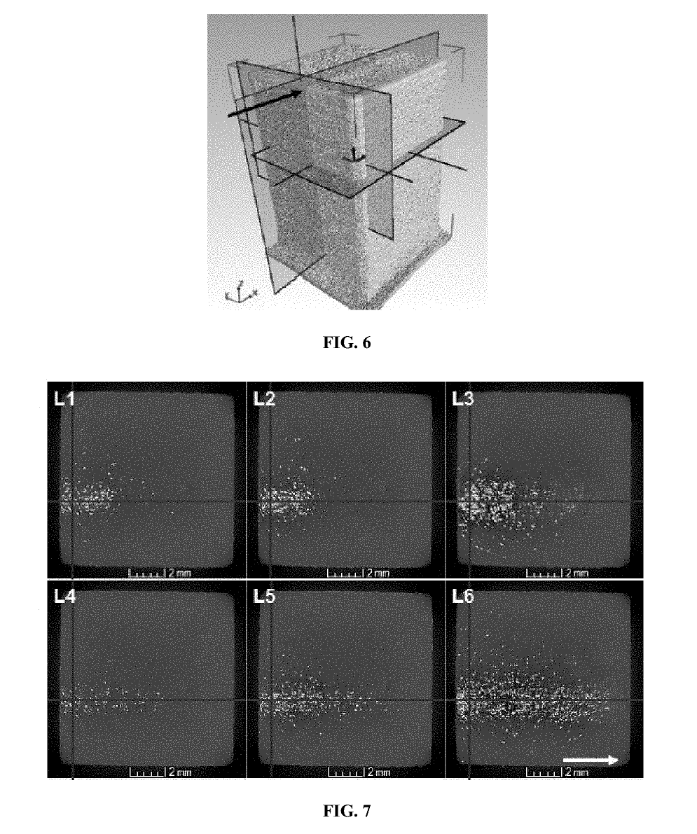

With regard to demonstrating the system and methods of the present invention, two materials, including one tungsten-based alloy powder and one aluminum-based alloy powder, were selected and tested as the secondary powders. In both cases, the primary powder was Inconel 625. Six levels of powder feed rates were successfully developed for each material. FIGS. 4-5 show images captured using a high resolution optical camera, during the calibration process. FIG. 4 includes multiple photographic images depicting the six levels of contamination deposition for tungsten and FIG. 5 includes multiple photographic images depicting the six levels of contamination deposition for AlSi10Mg. X-ray computed tomography (CT) was used to investigate the appropriate deposition of contaminant powders. FIG. 6 illustrates the 3D reconstruction of the specimen contaminated with the tungsten powder particles. The three planes represent the three axes of the Cartesian coordinate system and the recoating direction is shown by the black arrow in the Figure. FIG. 7 illustrates the horizontal (top) view of the tungsten powder distribution in the six contamination levels, embedded in a 10×10×15.20-mm specimen made of Inconel 625. There is a noticeable match between the calibration images shown in FIG. 4 and the actual distribution inside the specimen.

While the present invention has been illustrated by the description of exemplary embodiments thereof, and while the embodiments have been described in certain detail, it is not the intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1. A powder handling system for use in powder bed fusion additive manufacturing, comprising:
(a) a first powder deposition device for depositing a primary powder on a surface at a predetermined speed; and
(b) a second powder deposition device for depositing a secondary powder onto the primary powder in at least two directions relative to the surface, wherein the second powder deposition device includes:
(i) a reservoir for containing the secondary powder; and
(ii) a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, or a combination thereof.

2. The system of claim 1, wherein the rate of deposition of the secondary powder is further controlled by adjusting the speed of the first powder deposition device.

3. The system of claim 1, wherein the first powder deposition device further includes a recoater arm.

4. The system of claim 1, wherein the primary powder includes a nickel-based alloy.

5. The system of claim 1, wherein the secondary powder includes a tungsten-based alloy.

6. The system of claim 1, wherein the secondary powder includes an aluminum-based alloy.

7. The system of claim 1, wherein the at least two directions include movement along the X-axis of the surface and movement along the Y-axis of the surface.

8. A powder handling system for use in powder bed fusion additive manufacturing, comprising:
(a) a first powder deposition device for depositing a primary powder on a surface at a predetermined speed, wherein the wherein the first powder deposition device further includes a recoater arm; and
(b) a second powder deposition device for depositing a secondary powder onto the primary powder in at least two directions relative to the surface, wherein the at least two directions include movement along the X-axis of the surface and movement along the Y-axis of the surface, and wherein the second powder deposition device includes:
(i) a reservoir for containing the secondary powder; and
(ii) a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, or a combination thereof.

9. The system of claim 8, wherein the rate of deposition of the secondary powder is further controlled by adjusting the speed of the first powder deposition device.

10. The system of claim 8, wherein the primary powder includes a nickel-based alloy.

11. The system of claim 8, wherein the secondary powder includes a tungsten-based alloy.

12. The system of claim 8, wherein the secondary powder includes an aluminum-based alloy.

13. A powder handling system for use in powder bed fusion additive manufacturing, comprising:
(a) a first powder deposition device for depositing a primary powder on a surface at a predetermined speed, wherein the wherein the first powder deposition device further includes a recoater arm; and
(b) a second powder deposition device for depositing a secondary powder onto the primary powder in at least two directions relative to the surface, wherein the at least two directions include movement along the X-axis of the surface and movement along the Y-axis of the surface, and wherein the second powder deposition device includes:
(i) a reservoir for containing the secondary powder; and
(ii) a rotating shaft connected to the reservoir, wherein the rotating shaft includes a speed of rotation, an angle of rotation, a number of rotations, and a notch geometry, and wherein the rotating shaft is adapted to deposit the secondary powder onto the primary powder at a predetermined rate of deposition, and wherein the predetermined rate of deposition is controlled by adjusting the speed of rotation of the shaft, adjusting the angle of rotation of the shaft, adjusting the number of rotations of the shaft, adjusting the notch geometry of the shaft, adjusting the speed of the first powder deposition device, or a combination thereof.

14. The system of claim 13, wherein the primary powder includes a nickel-based alloy.

15. The system of claim 13, wherein the secondary powder includes a tungsten-based alloy.

16. The system of claim 13, wherein the secondary powder includes an aluminum-based alloy.
